(19) United States
(12) Patent Application Publication
(10) Pub. No.: US 2017/0058993 A1
(43) Pub. Date: Mar. 2, 2017

(54) VIBRATION DAMPING APPARATUS FOR AUTOMOBILE WHEEL

(71) Applicant: Man Hee LIM, Seo-gu (KR)

(72) Inventor: Man Hee LIM, Seo-gu (KR)

(21) Appl. No.: 14/886,247

(22) Filed: Oct. 19, 2015

(30) Foreign Application Priority Data
Sep. 2, 2015 (KR) 10-2015-0124190

(51) Int. Cl. F16F 15/14; B60B 7/04; B60B 7/00

(52) U.S. Cl. CPC F16F 15/1407; B60B 7/0013; B60B 7/04; B60B 2900/111; B60B 2900/131; B60B 2900/133

(57) ABSTRACT

There is provided a vibration damping apparatus for an automobile wheel which includes a disk member connected with an axle hub and a rim member mounted with a tire. The vibration damping apparatus comprises: an outside cap attachably/detachably connected to an outside surface of a spoke section connecting a hub mounting section connected to the axle hub and the rim member; and an outside vibration damping plate provided to the outside cap to be in contact with the spoke section to dampen vibration.

### CROSS-REFERENCE TO RELATED APPLICATION

This application claims the benefit of Korean Patent Application No. 10-2015-0124190, filed on Feb. 9, 2015, the disclosure of which is hereby incorporated herein by reference in its entirety.

### BACKGROUND OF THE INVENTION

Field of the Invention

The present invention relates to an automobile wheel and more particularly, to a vibration damping apparatus for an automobile wheel to attenuate vibration occurring in the wheel by installing the vibration damping apparatus in the wheel.

Description of the Related Art

In general, automobile wheels are made of steel or aluminum. This kind of a wheel is secured to a wheel hub having a brake drum or a brake disc by a round head screw or conical head screw.

To improve the fuel-efficiency of an automobile by decreasing the weight of the automobile, aluminum which is a light material has been used for an automobile wheel. Further, a technology to structurally lighten the weight has been also developed.

Usually, when a wheel is designed, it is considered to primarily satisfy the strength requirements. The structures, such as the thicknesses and designs of a hub mounting section and a spoke section of a wheel, have been designed to satisfy the minimum required strength of the wheel. Then, a process for secondary weight lightening (decrease of weight) has been performed inside the hub mounting section and the spoke section of the wheel to improve the fuel-efficiency.

However, as the wheel weight has been lightened through the aforementioned ways, the stiffness becomes insufficient, causing vibration and noise of the wheel during the driving of the automobile. To prevent these problems, casting thickness is again provided inside the hub mounting section and the spoke section of the wheel. Even the entire shape of the wheel is thickened, thereby increasing the unnecessary stiffness rather than the minimum required strength. This again increases the weight and therefore, it restricts the improvement of fuel-efficiency.

Korean Patent Application No. 10-2006-0044653 (hereinafter referred to as ‘Reference 1’) discloses a technology to decrease weight and block noise by forming a hollow chamber in a rim. The technology of forming the hollow chamber in the rim and spokes is disclosed in not only Reference 1 but also Korean Patent Application Nos. 10-2007-0053386 and 10-1999-0062973. The method of forming the hollow chamber has the effect of reducing weight and absorbing noise but it has a problem in that durability is weakened.

Korean Patent Published Application No. 10-2007-0053386 (hereinafter referred to as ‘Reference 2’) discloses a technology to absorb noise and vibration by forming a hollow chamber in a rim and filling it with an aluminum foam core. The technology of forming the hollow chamber in the rim and spokes and filling it with the foam core has a better effect of absorbing noise in comparison with Reference 1 but a less effect in reducing weight.

The aforementioned automobile wheels and the technology thereof are disclosed in detail in 1: Korean Patent Application No. 10-2006-0044653; 2: Korean Patent Application No. 10-2007-0053386; 3: Korean Patent Published Application No. 10-1999-0062973; and 4: Korean Patent Application No. 10-2001-0072401. These publications are hereby incorporated by reference in their entireties into this application to fully illustrate the state of the art.

### SUMMARY OF THE INVENTION

Therefore, it is an object of the present invention to solve the above problems and to provide a vibration damping apparatus for an automobile wheel by installing the vibration damping apparatus in a spoke section of the automobile wheel, to attenuate vibration and noise occurring in the automobile wheel itself.

It is an another object of the present invention to provide a vibration damping apparatus for an automobile wheel by installing the vibration damping apparatus between the automobile wheel and a hub cap, to attenuate vibration and noise occurring in the automobile wheel itself.

It is an another object of the present invention to provide a vibration damping apparatus for an automobile wheel by making the vibration damping apparatus installed in the automobile wheel by using vibration damping rubber, to lighten the weight of the wheel itself.

In accordance with an embodiment of the present invention, there is provided a vibration damping apparatus for an automobile wheel which includes a disk member connected with an axle hub and a rim member mounted with a tire, the vibration damping apparatus comprising: an outside cap attachably/detachably connected to an outside surface of a spoke section connecting a hub mounting section connected to the axle hub and the rim member; and an outside vibration damping plate provided to the outside cap to be in contact with the spoke section, to dampen vibration.

The outside vibration damping plate may have both ends which are different from each other in thickness, such that the thickness gradually increases from one end to the other end, where one end is thicker relative to the opposite end which is thinner. Further, the outside vibration damping plate may be provided such that the thicker end is positioned towards the rim member and the thinner end is positioned towards the hub mounting section.

Further, the outside vibration damping plate may have a cavity formed to be indented at its surface facing the spoke section and the spoke section may include a through hole being operatively connected to the cavity of the outside vibration damping plate.

The vibration damping apparatus for an automobile wheel may further comprise: a side cap attachably/detachably connected to an inner surface of a decorative open space formed two adjacent spoke sections of the disk member; and a side vibration damping plate provided to the side cap to be in contact with the inner surface of the decorative open space, to dampen vibration.

The vibration damping apparatus for an automobile wheel may further comprise; a damper rubber provided to be in contact with an inside surface of the spoke section of the disk member.

The damper rubber may include a through hole to be aligned with and operatively connected to the through hole of the spoke section.

The vibration damping apparatus for an automobile wheel may further comprise: a hub cap attachably/detachably connected to an outside surface of the hub mounting section of the disk member; a vibration damping plate in the shape corresponding to the hub cap provided to an inside surface of the hub cap to be in contact with the hub mounting section, to dampen vibration; and a vibration damping bushing provided to the vibration damping plate to be in contact with the hub mounting section, to dampen vibration.

The hub cap may include a number of connection ribs inserted into and connected to a hub hole of the hub mounting section, the connection ribs may receive a back cap, and the back cap may receive a vibration damping member to be in contact together.

The back cap may include a skirt portion which is inclined inwardly at its one side, to support the vibration damping member inserted into the back cap.

Further, the outside vibration damping plate, the side vibration damping plate, the damper rubber, the vibration damping plate, the vibration damping bushings, and the vibration damping member may be formed of chloroprene rubber (CR), nitrile rubber (NBR: nitrile-butadiene rubber), ethylene propylene rubber (EPDM: ethylene propylene diene monomer), fluororubber (FPM; fluorocarbon rubber), polybutadiene rubber (BR) or styrene-butadiene rubber (SBR).

### Advantageous Effects of the Invention

According to the vibration damping apparatus for an automobile wheel of the present invention, the vibration and noise occurring in the automobile wheel is attenuated by the vibration damping apparatus provided between the wheel and the hub cap.

Further, according to the vibration damping apparatus for an automobile wheel of the present invention, since the vibration damping apparatus is made of a rubber material, the vibration and noise of the wheel itself are attenuated and the weight of the wheel itself is lightened.

### BRIEF DESCRIPTION OF THE FIGURES

The above and other features and advantages of the present invention will become more apparent to those of ordinary skill in the art by describing in detail the preferred embodiments thereof with reference to the attached figures.

FIG. 1 shows an automobile wheel according to a first embodiment of the present invention.

FIG. 2 is a cross-sectional view of the automobile wheel, taken along Line a-a shown in FIG. 1.

FIG. 3 shows an automobile wheel according to a second embodiment of the present invention.

FIG. 4 is a cross-sectional view of the automobile wheel, taken along Line b-b shown in FIG. 3.

FIG. 5 shows an automobile wheel according to a third embodiment of the present invention.

FIG. 6 is a cross-sectional view of the automobile wheel, taken along Line c-c shown in FIG. 5.

FIG. 7 shows an automobile wheel according to a fourth embodiment of the present invention.

FIG. 8 is a cross-sectional view of the automobile wheel, taken along Line d-d shown in FIG. 7.

FIG. 9 is an exploded view of a vibration damping plate, a vibration damping bushing, a back cap and a vibration damping member of the automobile wheel according to the present invention.

FIG. 10 is a cross-sectional view of an automobile wheel according to a fifth embodiment of the present invention.

FIG. 11 is a cross-sectional view of an automobile wheel according to a sixth embodiment of the present invention.

Description of the reference numbers in the figures:

| | |
|---|---|
| 100: disk member | 110: hub mounting section |
| 120: hub hole | 130: bolt hole |
| 131: securing portion | 132: insertion hole |
| 140: cavity | 150: spoke section |
| 151: outside surface | 151a: insertion groove |
| 151b: through hole | 152: inside surface |
| 153: decorative open space | 154: inner surface |
| 154a: insertion groove | 160: rim member |
| 161, 161a: flanges | 162, 162a: bead seats |
| 163: well portion | 164: well wall |
| 200: hub cap | 210: through hole |
| 211: connection ribs | 300: vibration damping plate |
| 310: flat portion | 311: central hole |
| 330: connection boss | 331: through hole |
| 400: vibration damping bushing | 410: through hole |
| 420: skirt portion | 500: back cap |
| 510: skirt portion | 600: vibration damping member |
| 610: flange portion | |
| 700, 700a, 700b: outside vibration | |
| damping plates | |
| 700a-1, 700b-1: thicker end | |
| 700a-2, 700b-2: thinner end | |
| 700b-5 cavity | 710: outside cap |
| 800: side vibration damping plate | 810: side cap |
| 900: damper rubber | 900a: through hole |

### DETAILED DESCRIPTION OF THE INVENTION

The present invention will now be described more fully hereinafter with reference to the accompanying drawings, in which the preferred embodiment(s) of the invention is shown so that those of ordinary skill in the art can easily carry out the present invention.

The terms used herein are defined in consideration of the function(s) in the present invention and therefore, these terms may vary according to the intention or practice of a user or an operator. Accordingly, the definition of these terms shall be interpreted as having their meaning and concept in the context of the technical detail to work the invention rather than the simple names of the terms.

Further, the embodiments of the present invention do not limit the scope of the present invention but are just examples of the constituent elements described in the claims of the present invention. Accordingly, the embodiments including alternative constituent elements which are included in the technical idea throughout the specification of the invention and which are alternative as the equivalents in the constituent elements of the claims can be included in the scope of the claims of the invention.

Further, terms selected in the embodiments are used to distinguish one constituent element from the other constituent element(s) and therefore, the constituent elements shall not be limited by the terms. In describing the present invention, any detailed description of the relevant publicly known technology, which makes the gist of the present invention unnecessarily obscure, will not be presented herein.

In the description of the present invention, based on a wheel of an automobile, a side towards the outside of a disk member and a rim member is referred to an “outside” and the side towards the internal space formed by the disk member and the rim member is referred to an “inside”.

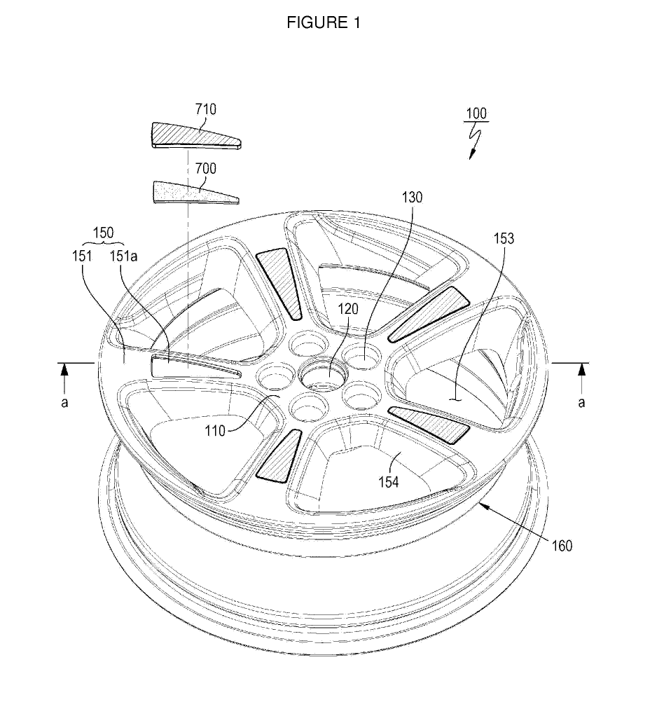

FIGS. 1 through 11 illustrate vibration damping apparatuses for an automobile wheel according to the embodiments of the present invention.

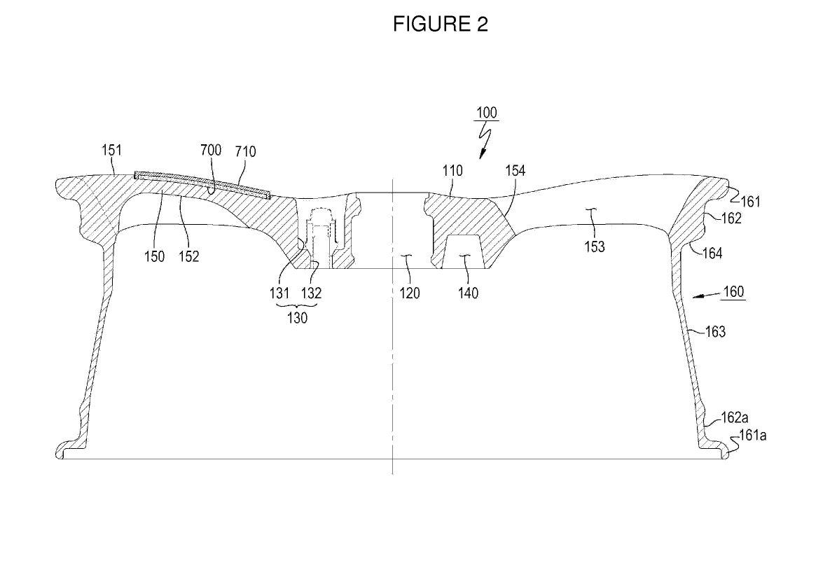

As shown in FIGS. 1 and 2, in automobile wheel according to the first embodiment of the present invention includes a disk member 100 with which an axle hub (not shown) is connected and a rim member 160 on which a tire (not shown) is mounted.

The disk member 100 includes a hub mounting section 110 and a spoke section 150. The hub mounting section 110 is in a disk shape, to be connected with the axle hub. The spoke section 150 radially extends from the outside of the hub mounting section 110 to the rim member 160.

Specially, as shown in FIG. 2, the hub mounting section 110 is formed in a solid type, except for a bolt hole 130 and a cavity 140 to fasten the axle hub using a bolt.

In this automobile wheel, a section connected with the axle hub (not shown) is a support end to receive the load of a cantilever. Therefore, the reason to make the solid hub mounting section 110 is for the support end to have the strength to bear the weight of the automobile itself and the impact load.

A hub hole 120 is formed in the center of the hub mounting section 110. A number of bolt holes 130 are formed, at regular intervals, in a circumferential direction, spaced apart from the hub hole 120, on the outside of the hub mounting section 110.

Each of the bolt holes 130 comprises a securing portion 131 and an insertion hole 132. The securing portion 131 is formed on the outside surface of the disk member 100 and has a relatively wide diameter so that a nut or cap nut to be inserted from the outside is secured. The insertion hole 132 is formed by extending to the inside surface of the disk member 100 and has a relatively narrow diameter so that a bolt provided to the axle hub passes through. The bolt of the axle hub, which passes through the insertion hole 132 of the bolt hole 130, is securely connected with the nut or cap nut.

The cavity 140 is provided between the bolt holes 130. A damper (not shown) made of a rubber material may be inserted into the cavity 140. The cavity 140 is formed in the disk member 100, to be opposite to the bolt hole 130, that is, on the inside surface of the disk member 100. The cavity 140 is formed such that its diameter becomes gradually smaller from the inside surface of the disk member 100 towards the center thereof.

This is to attenuate vibration and noise occurring in the wheel itself during the driving of the automobile by the cavity 140 having the diameter which becomes gradually bigger towards the inside end of the disk member 100 and the damper.

The securing portion 131 of the bolt hole 130 and the cavity 140 are positioned so as to be opposed to each other, thereby mutually reinforcing the strength of the disk member 100. That is, on the outside surface of the disk member 100, the interval between the hub hole 120 and the securing portion 131 is narrow but it is possible to maintain the strength by the solid hub mounting section 110 where the cavity 140 is not formed. On the inside surface of the disk member 100, the interval between the hub hole 120 and the cavity 140 is narrow but it is possible to maintain the strength since the space between the hub hole 120 and the insertion hole 132 of the bolt hole 130 is wide.

When the tire is mounted on the rim member 160 of the automobile wheel, a closed ring-shaped space is formed between the rim member 160 and the tire.

As shown in FIG. 2, the rim member 160 comprises: flanges 161, 161a, bead seats 162, 162a, a well portion 163 and a well wall 164. The flanges 161, 161a are each positioned at the outside and inside ends of the rim member 160, to be in contact with the outer surfaces of both ends of the tire by side to side. The bead seats 162, 162a each extend from the flanges 161, 161a, to be formed in a flat surface to be in contact with both beads of the tire by side to side and to securely support the beads to be sit.

The well portion 163 is formed to be stepped between the bead seats 162, 162a, to have a diameter which is smaller than the diameter of the bead seats 162, 162a. The well wall 164 is formed to connect the outside bead seat 162 with the well portion 163.

The well portion 163 has the diameter which is smaller than the diameter of the bead seats 162, 162a such that the beads of the tire, which are in contact with the bead seats 162, 162a by side to side, release in the well portion 163.

As shown in FIGS. 1 and 2, an outside cap 710 is provided to be attachable to/detachable from an outside surface 151 of each of the spoke sections 150 of the disk member 100.

The outside cap 710 may be in a round, oval or polygonal shape corresponding to the spoke section 150. The outside cap may be formed of a plastic material. One or more outside caps 710 may be provided to the outside surface 151 of each spoke section 150.

Further, an outside vibration damping plate 700 in the shape corresponding to the outside cap 710 is provided to the inside surface of the outside cap 710 facing the outside surface 151 of the spoke section 150.

An insertion groove 151a in the shape corresponding to the outside cap 710 is formed on the outside surface 151 of the spoke section 150 provided with the outside cap 710. The outside cap 710 is inserted into the insertion groove 151a to be connected together, so that both side surfaces of the outside vibration damping plate 700 are each in contact with the insertion groove 151a and the inside surface of the outside cap 710.

The outside vibration damping plate 700 is formed of compressed rubber having a uniform thickness and is positioned between the outside cap 710 and the spoke section 150 such that both side surfaces of the outside vibration damping plate 700 are each in contact with the outside cap 710 and the spoke section 150 by side to side. Therefore, the outside vibration damping plate 700 absorbs and attenuates the vibration and noise occurring in the wheel itself during the driving of the automobile.

Specifically, the vibration occurring in the axle hub is transferred to the hub mounting section 110 and the vibration occurring in the tire is transferred to the rim member 160, so that the vibration which is transferred in two directions is concentrated in the spoke section 150 connecting the hub mounting section 110 and the rim member 160. Then, the outside vibration damping plate 700 provided to the outside surface 151 of the spoke section 150 directly absorbs and efficiently attenuates the vibration concentrated to the spoke section 150.

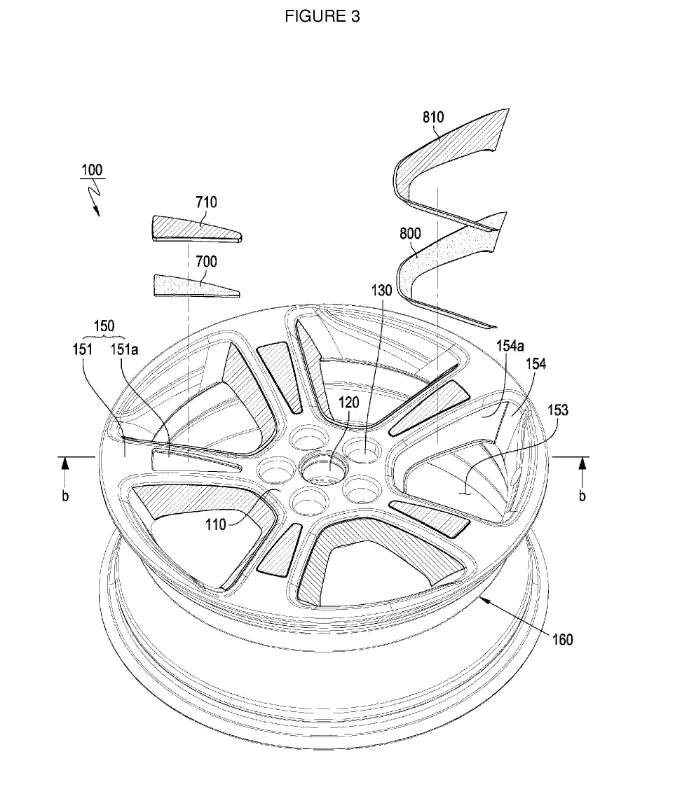

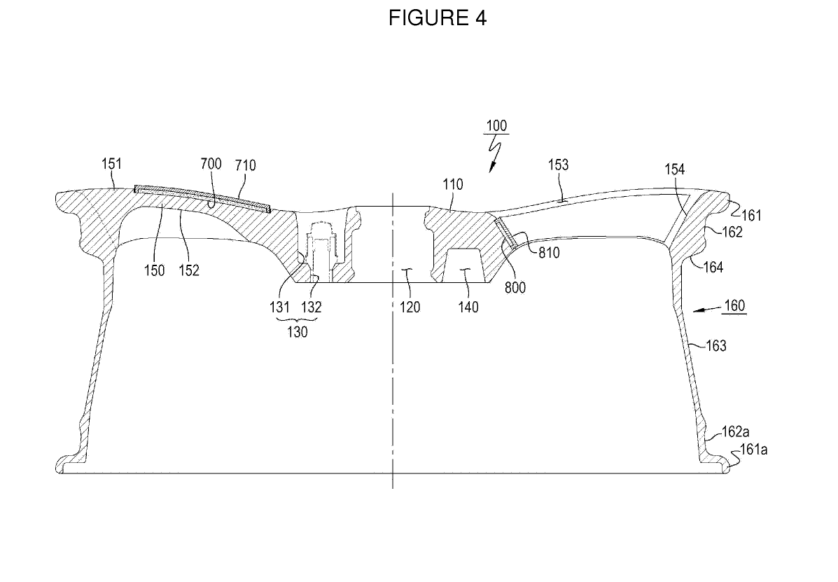

FIGS. 3 and 4 show an automobile wheel according to the second embodiment of the present invention. The same reference numerals will be given to the same constituent elements of the first embodiment, and no further description of the unnecessarily overlapping content will be presented.

Accordingly, in this embodiment, only a vibration damping apparatus provided to the side of the spoke section will be described in detail.

As shown in FIGS. 3 and 4, the vibration damping apparatus according to the second embodiment of the present invention, a decorative open space 153 is formed between the two adjacent spoke sections 150 of the disk member 100.

The decorative open space 153 is formed in a closed curve by the two adjacent spoke sections 150, the hub mounting section 110 and the rim member 160. A side cap 810 is provided to be attached to/detached from an inner surface 154 of the decorative open space 153 (that is, the sides of the adjacent spoke sections 150 and the side of the hub mounting section 110).

The side cap 810 may be formed in a round, oval or polygonal shape. However, the side cap 810 in this embodiment is in the “U” shape corresponding to the inner surface 154 of the decorative open space 153 and is formed of a plastic material.

A side vibration damping plate 800 is insertedly and securely provided to an inside surface of the side cap 810. One surface of the side vibration damping plate 800 is in contact with the inner surface 154 of the decorative open space 153. An insertion groove 154a in the “U” shape corresponding to the side cap 810 is formed at the inner surface 154 of the decorative open space 153 where the side cap 810 is provided. The side cap 810 is inserted into the insertion groove 154a to be connected together, such that both side surfaces of the side vibration damping plate 800 are each in contact with the insertion groove 154a and the inside surface of the side cap 810.

The side vibration damping plate 800 is formed of compressed rubber having a uniform thickness and its both side surfaces are each in contact with the side cap 810 and the insertion groove 154a of the decorative open space 153 by side to side. Therefore, the side vibration damping plate 800 absorbs and attenuates the vibration and noise occurring in the wheel itself during the driving of the automobile.

Differently from the aforementioned embodiment, only the side vibration damping plate 800 may be provided to the spoke sections 150. However, together with the outside vibration damping plate 700 according to the first embodiment, the side vibration damping plate 800 is provided to the spoke sections 150. In this case, when the vibration occurring in the axle hub and transferred to the hub mounting section 110 and the vibration occurring in the tire and transferred to the rim member 160 are concentrated to the spoke sections 150 connecting the hub mounting section 110 and the rim member 160, the side vibration damping plate 800 and the outside vibration damping plate 700 provided to the spoke sections 150 directly absorb and efficiently attenuate the vibration concentrated to the spoke sections 150.

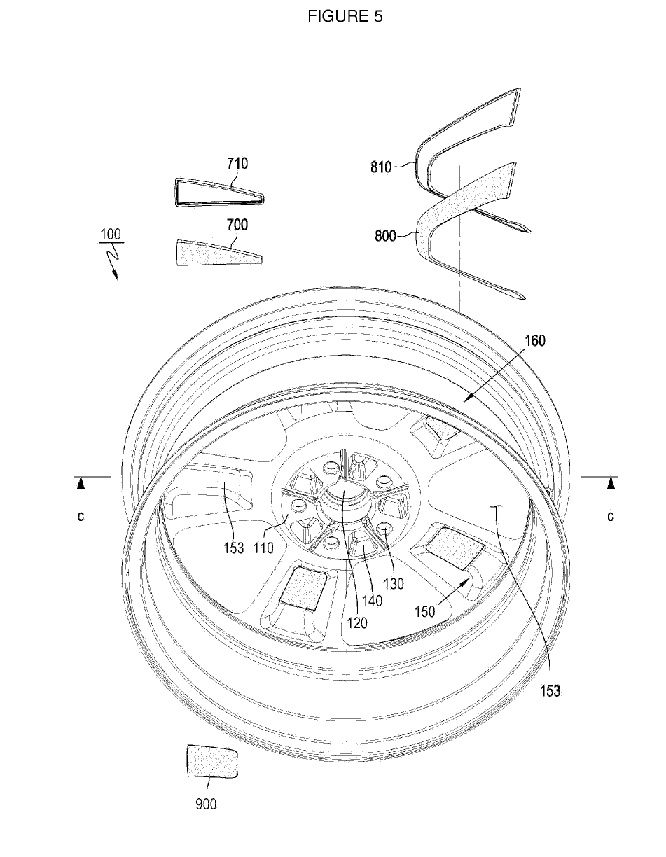

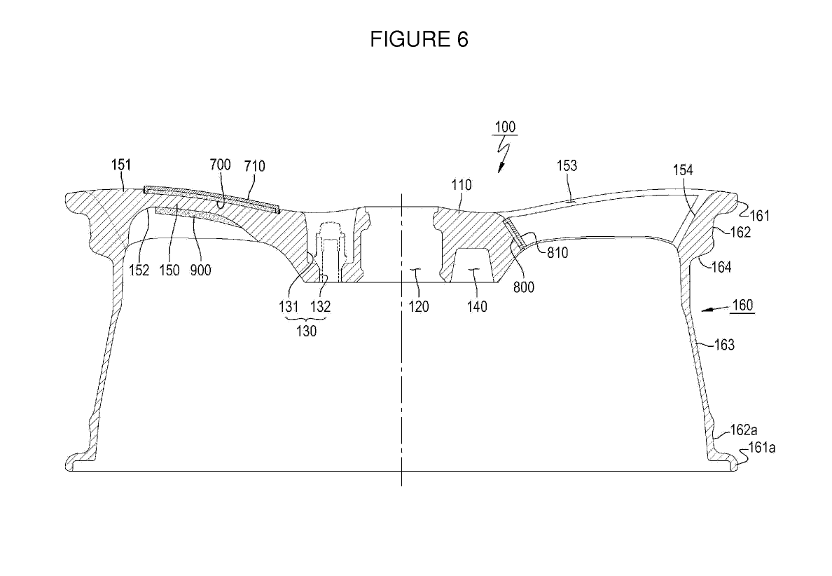

FIGS. 5 and 6 show an automobile wheel according to the third embodiment of the present invention. The same reference numerals will be given to the same constituent elements of the first embodiment, and no further description of the unnecessarily overlapping content will be presented.

Accordingly, in this embodiment, only a vibration damping apparatus provided to the inside surface of the spoke section will be described in detail.

As shown in FIGS. 5 and 6, the vibration damping apparatus according to the third embodiment of the present invention, a damper rubber 900 is attached and secured to the inside surface 152 of each of the spoke section 150 of the disk member 100.

The damper rubber 900 has a round, oval or polygonal shape and is formed of a compressed rubber having a uniform thickness. The damper rubber 900 is provided such that its one surface is in contact with the inside surface 152 of the spoke section 150 by side to side, to absorb and attenuate the vibration and noise occurring in the wheel itself during the driving of the automobile.

Differently from the aforementioned embodiments, only the damper rubber 900 may be provided to the spoke sections 150. However, the damper rubber 900, the outside vibration damping plate 700 and the side vibration damping plate 800 according to the aforementioned embodiments may be together provided to the spoke sections 150. In this case, when the vibration occurring in the axle hub and transferred to the hub mounting section 110 and the vibration occurring in the tire and transferred to the rim member 160 are concentrated to the spoke sections 150 connecting the hub mounting section 110 and the rim member 160, the damper rubber 900, the side vibration damping plate 800 and the outside vibration damping plate 700 provided to the spoke sections 150 directly absorb and efficiently attenuate the vibration concentrated to the spoke sections 150.

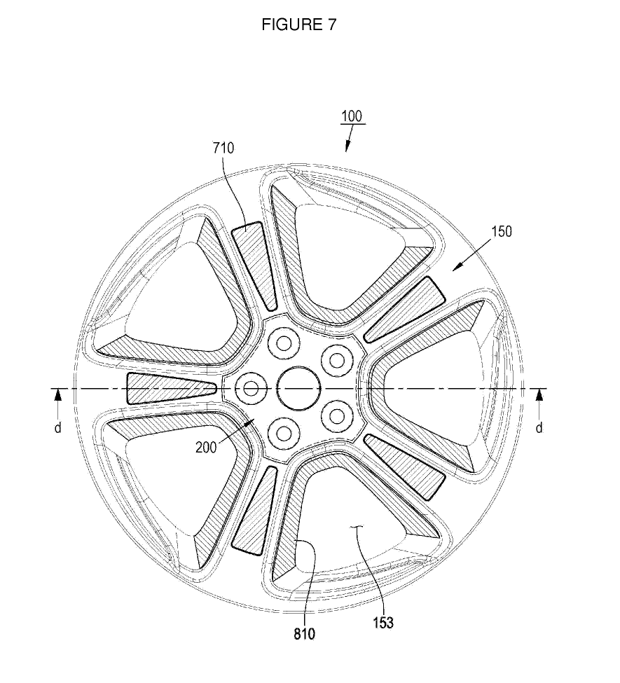

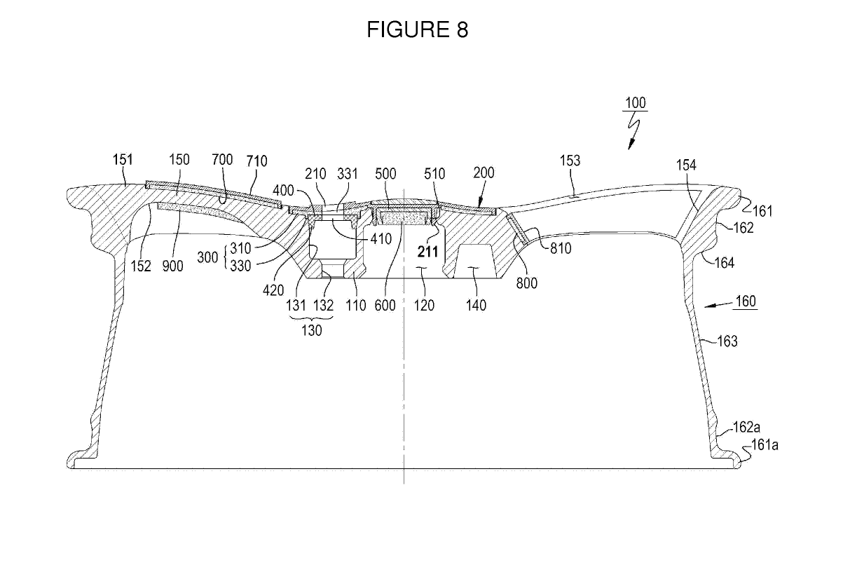

FIGS. 7 and 8 show an automobile wheel according to the fourth embodiment of the present invention. The same reference numerals will be given to the same constituent elements of the first embodiment, and no further description of the unnecessarily overlapping content will be presented.

Accordingly, in this embodiment, only a vibration damping apparatus provided to the hub cap and the hub mounting section will be described in detail.

As shown in FIGS. 7 and 8, the vibration damping apparatus according to the fourth embodiment of the present invention comprises a vibration damping plate 300 and a vibration damping bushing 400 which are positioned one by one between the hub mounting section 110 and the hub cap 200 to be attachable to/detachable from the outside surface of the hub mounting section 110.

The hub cap 200 is made of a plastic material. The hub cap 200 may be formed in a round or polygonal shape to cover the bolt holes 130 of the hub mounting section 110. Otherwise, the hub cap 200 may be formed in a radial shape not to cover the bolt holes 130 of the hub mounting section 110. In the embodiment of the present invention, for example, the hub cap 200 having a polygonal shape will be described.

The hub cap 200 in the polygonal shape includes through holes 210 and connection ribs. The connection ribs 211 protrude in the center of the inside surface of the hub cap 200, to be inserted into and connected with the hub hole 120. The through holes 210 are formed at the circumference direction corresponding to the bolt holes 130 of the hub mounting section 110 and each of the through holes 210 is bored in the diameter corresponding to the insertion hole 132 of the bolt hole 130.

The vibration damping plate 300 is formed of compressed rubber having a uniform thickness, has the shape corresponding to the hub cap 200 and is connected to the inside surface of the hub cap 200.

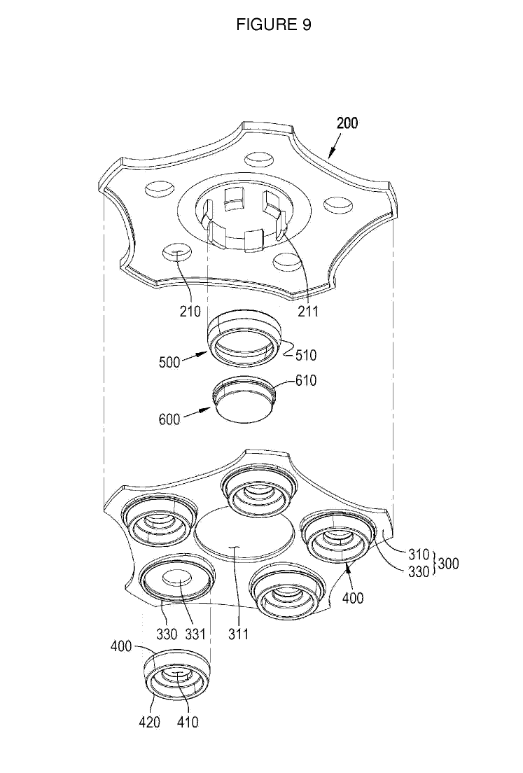

As shown in FIG. 9, the vibration damping plate 300 in the corresponding shape of the hub cap 200 includes a flat portion 310 to be connected to the inside surface of the hub cap 200 and connection bosses 330 protruding from the inside surface of the flat portion 310.

The flat portion 310 of the vibration damping plate 300 is provided such that the whole outside surface of the flat portion 310 is in contact with the inside surface of the hub cap 200 by side to side. The flat portion 310 includes the central hole 311 in its center. Each of the connection bosses 330 includes a through hole 331 in its center. The through hole 331 corresponding to the through hole 210 of the hub cap 200 is formed through the flat portion 310 to be collinear with the through hole 210 of the hub cap 200.

The connection ribs 211 of the hub cap 200 to be connected to the hub hole 120 are inserted through the central hole 311. A bolt which is provided to the axle hub and passes through the insertion hole 132 of the bolt hole 130 is inserted in the through hole 331 of the connection boss 320.

The vibration damping bushing 400 is formed of compressed rubber and includes a through hole 410 formed in its center and a skirt portion 420 protruding in one direction in its outer circumference portion. The vibration damping bushing 400 is inserted in the connection boss 330 of the vibration damping plate 300, the through hole 410 of the vibration damping bushing 400 is provided to be collinear with the through hole 331 of the vibration damping plate 300, and the skirt portion 420 of the vibration damping bushing 400 protrudes towards the hub mounting section 110, to be inserted in and internally in contact with the bolt hole 130 of the hub mounting section 110.

Therefore, since the vibration damping bushing 400 is in contact with the vibration damping plate 300 and the hub mounting section 110 by side to side, the vibration damping plate 300 is in contact with the hub cap 200 and the vibration damping bushing 400 by side to side, the vibration and noise occurring in the wheel itself during the driving of the automobile are absorbed and attenuated by the vibration damping plate 300 and the vibration damping bushing 400. Specifically, since the contact area between the vibration damping bushings 400 and the hub mounting section 110 is maximized through the skirt portions 420 of the vibration damping bushings 400 being internally in contact with the bolt holes 130 of the hub mounting section 110, the vibration and noise occurring in the automobile wheel are maximally attenuated.

The vibration damping plate 300 and the vibration damping bushings 400 may be provided with the outside vibration damping plate 700, the side vibration damping plate 800 and the damper rubber 900 according to the aforementioned embodiments. In this case, the vibration and noise occurring in the automobile wheel itself during the driving of the automobile are maximally absorbed and attenuated by the vibration damping plate 300, the vibration damping bushings 400, the outside vibration damping plate 700, the side vibration damping plate 800, the damper rubber 900, the bolt holes 130 of the hub mounting section 110 and the cavities 140. Further, the weight of the automobile wheel is lightened by the bolt holes 130 of the hub mounting section 110 and the cavities 140.

Further, a back cap 500 is inserted into and connected with the connection ribs 211 of the hub cap 200. The back cap 500 in a round shape is formed of a plastic material. The back cap 500 includes a skirt portion 510 protruding from its one surface towards the hub hole 120 of the disk member 100. An end of the skirt portion 510 is inwardly bent, to firmly support and connect with a vibration damping member 600 (to be described below) which is inserted into the inside of the skirt portion 510.

The vibration damping member 600 is formed of a round rubber material and inserted into the back cap 500. The vibration damping member 600 includes a flange portion 610 protruding outwardly from its one surface facing the inside surface of the back cap 500. Therefore, as shown in FIG. 8, the vibration damping member 600 having a relatively smaller diameter than the flange portion 610 is firmly inserted and supported in the skirt portion 510 which is inclined inwardly in the black cap 500.

Specifically, the back cap 500 and the vibration damping member 600 provided to the connection ribs 211 of the hub cap 200 may be provided to the hub cap 200, separately from the vibration damping plate 300 or the vibration damping bushing 400 according to the aforementioned embodiments. However, more preferably, as shown in FIG. 9, the back cap 500 and the vibration damping member 600 are provided, together with the aforementioned vibration damping plate 300 and vibration damping bushing 400, to further improve the vibration damping function of the automobile wheel.

The outside vibration damping plate 700, the side vibration damping plate 800, the damper rubber 900, the vibration damping plate 300, the vibration damping bushings 400 and the vibration damping member 600 may be formed of anyone of chloroprene rubber (CR), nitrile rubber (NBR: nitrile-butadiene rubber), ethylene propylene rubber (EPDM: ethylene propylene diene monomer), fluororubber (FPM; fluorocarbon rubber), polybutadiene rubber (BR), styrene-butadiene rubber (SBR), isobutylene isoprene rubber (IIR) and chlorosulphonated polyethylene (CSM) rubber which are excellent in ageing resistance, weatherproof, ozone resistance and oil resistance and have a nonflammable characteristic in comparison with natural rubber.

Since the properties of the aforementioned rubber are well-known, no detailed description thereof will be presented.

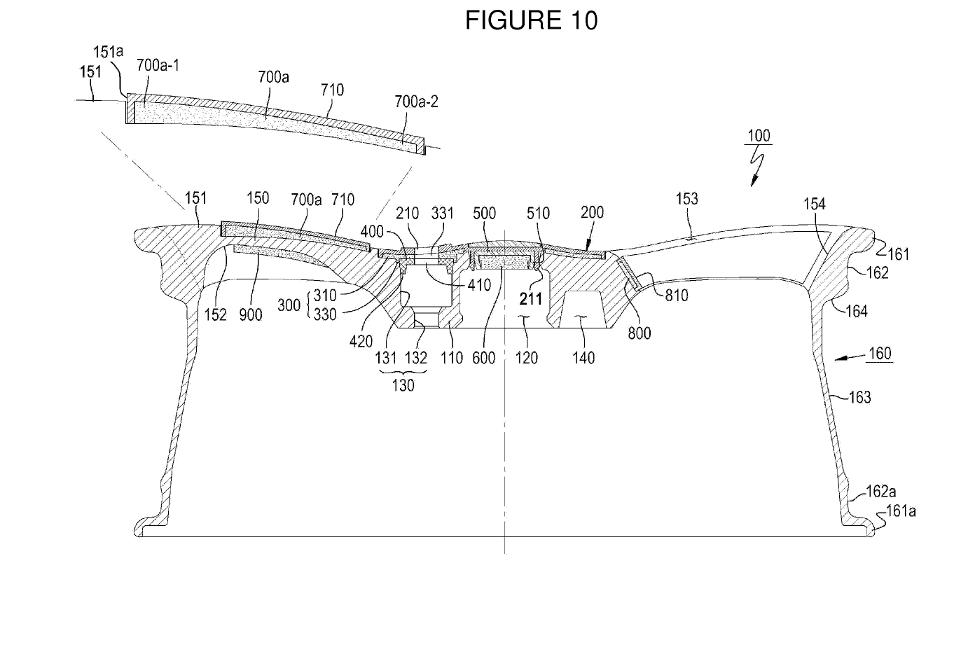

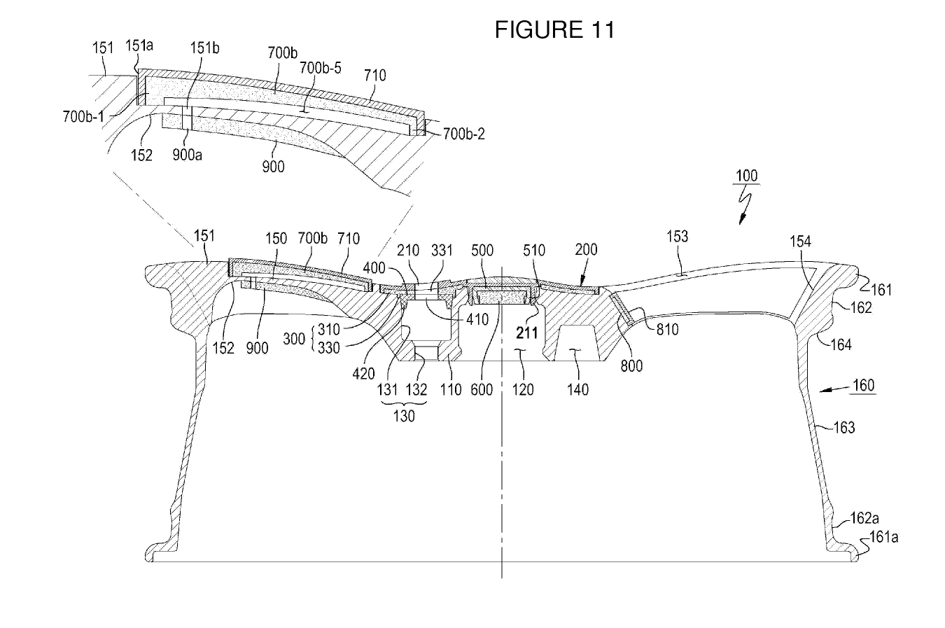

FIGS. 10 and 11 are cross-sectional views of automobile wheels according to the fifth and sixth embodiments of the present invention. The same reference numerals will be given to the same constituent elements of the first embodiment, and no further description of the unnecessarily overlapping content will be presented.

These embodiments are the same as the fourth embodiment described above, expect for an outside vibration damping plate. Therefore, in these embodiments, only the outside vibration damping plate will be described in detail.

As shown in FIG. 10, in the vibration damping apparatus according to the fifth embodiment of the present invention, an insertion groove 151a is formed at an outside surface 151 of each of the spoke sections 150 and an outside cap 710 is provided to be attached to/detached from the insertion groove 151a.

An outside vibration damping plate 700a facing the insertion groove 151a of the spoke section 150 is provided inside the outside cap 710. One surface, that is, the inside surface, of the outside vibration damping plate 700a is in contact with the insertion groove 151a of the spoke section 150 by side to side.

The outside vibration damping plate 700a is formed of compressed rubber and its both ends are formed to be different from each other in thickness. That is, one end 700a-1 of the outside vibration damping plate 700a is thicker relative to the opposite end 700a-2 which is thinner.

The thicker end 700a-1 of the outside vibration damping plate 700a is positioned towards the rim member 160 and the thinner end 700a-2 is positioned towards the hub mounting section 110. The vibration of the wheel most greatly occurs in the rim member 160 and the vibration occurring in the rim member 160 is transferred to the axle hub connected to the hub mounting section 110 through each of the spoke sections 150. Then, since the outside vibration damping plate 700a is provided to the spoke section 150 such that the thicker end 700a-1 of the outside vibration damping plate 700a is positioned towards the rim member 160, the vibration is effectively attenuated in the outside vibration damping plate 700a before the vibration is transferred to the axle hub. Further, since the thinner end 700a-2 of the outside vibration damping plate 700a is positioned towards the hub mounting section 110, the intensity of the hub mounting section 110 is secured and the maximum effect of damping vibration is obtained.

The big vibration occurring in the rim member 160 of the wheel is most absorbed in the thicker end 700a-1 of the outside vibration damping plate 700a and simultaneously, the remaining vibration is transferred to the thinner end 700a-2, to be continuously absorbed and attenuated.

As shown in FIG. 11, the vibration damping apparatus according to the sixth embodiment of the present invention has the same structure as that of the fifth embodiment. However, in the sixth embodiment, one end 700b-1 of an outside vibration damping plate 700b is thicker relative to the opposite end 700b-2 which is thinner. The thicker end 700b-1 is positioned towards the rim member 160 and the thinner end 700b-2 is positioned towards the hub mounting section 110. The outside vibration damping plate 700b further has a Helmholtz resonance absorption function.

That is, a cavity 700b-5 is formed in the inside surface of the outside vibration damping plate 700b facing the insertion groove 151a of the spoke section 150. The cavity 700b-5 is indented to be spaced apart from the outside surface of the insertion groove 151a. A through hole 151b through the spoke section 151 is operatively connected to the cavity 700b-5 of the outside vibration damping plate 700b.

Accordingly, the vibration and noise are transferred to the cavity 700b-5 through the through hole 151b of the spoke section 151 and attenuated within the cavity 700b-5, thereby performing the Helmholtz resonance absorption function.

Further, in the case where the damper rubber 900 is provided to the inside surface of the spoke section 151, a through hole 900a to be aligned with the through hole 151b of the spoke section 151 is formed in the damper rubber 900, as shown in FIG. 11.

Specifically, the through holes 151b, 900a each have the sound wave frequency for attenuation according to the capacity, the opening diameters and lengths of an entry and exit. Therefore, the capacity, the opening diameters and lengths of the entry and exit of each of the through holes 151b, 900a are defined to enable to attenuate the sound wave of a specific frequency band (for example, 180 Hz 270 Hz) causing resonance in road noise occurring during the driving of the automobile.

Therefore, the road noise occurring during the driving of the automobile is maximally reduced by the cavity 700b-S of the outside vibration damping plate 700b, the through holes 151b, 900a of the spoke section 151 and damper rubber 900.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents.

Simple modifications or similar arrangements of the present invention belong to the category of the invention and therefore, the protection range of the invention will be apparent by the claims attached herewith.

What is claimed is:

1. A vibration damping apparatus for an automobile wheel which includes a disk member (100) connected with an axle hub and a rim member (160) mounted with a tire, comprising:
an outside cap (710) attachably/detachably connected to an outside surface (151) of a spoke section (150) connecting a hub mounting section (110) connected to the axle hub and the rim member (160); and
an outside vibration damping plate (700, 700a or 700b) provided to the outside cap (710) to be in contact with the spoke section (150), to dampen vibration.

2. The vibration damping apparatus for an automobile wheel according to claim 1, wherein the outside vibration damping plate (700a) has both ends which are different from each other in thickness, such that the thickness gradually increases from one end to the other end, where one end (700a-1) is thicker relative to the opposite end (700a-2) which is thinner.

3. The vibration damping apparatus for an automobile wheel according to claim 2, wherein the outside vibration damping plate (700a) is provided such that the thicker end (700a-1) is positioned towards the rim member (160) and the thinner end (700a-2) is positioned towards the hub mounting section (110).

4. The vibration damping apparatus for an automobile wheel according to claim 1, wherein the outside vibration damping plate (700b) has a cavity (700b-5) formed to be indented at its surface facing the spoke section (150).

5. The vibration damping apparatus for an automobile wheel according to claim 4, wherein the spoke section (150) includes a through hole (151b) being operatively connected to the cavity (700b-5) of the outside vibration damping plate (700b).

6. The vibration damping apparatus for an automobile wheel according to claim 5, further comprising a damper rubber (900) provided to be in contact with an inside surface (152) of the spoke section (150) of the disk member (100).

7. The vibration damping apparatus for an automobile wheel according to claim 6, wherein the damper rubber (900) includes a through hole (900a) to be aligned with and operatively connected to the through hole (151b) of the spoke section (150).

8. The vibration damping apparatus for an automobile wheel according to claim 1, further comprising:
a side cap (810) attachably/detachably connected to an inner surface (154) of a decorative open space (153) formed two adjacent spoke sections (150) of the disk member (100); and
a side vibration damping plate (800) provided to the side cap (810) to be in contact with the inner surface (154) of the decorative open space (153), to dampen vibration.

9. The vibration damping apparatus for an automobile wheel according to claim 1, further comprising:
a hub cap (200) attachably/detachably connected to an outside surface of the hub mounting section (110) of the disk member (100);
a vibration damping plate (300) in the shape corresponding to the hub cap (200) provided to an inside surface of the hub cap (200) to be in contact with the hub mounting section (110), to dampen vibration; and
a vibration damping bushing (400) provided to the vibration damping plate (300) to be in contact with the hub mounting section (110), to dampen vibration.

10. The vibration damping apparatus for an automobile wheel according to claim 9, wherein the hub cap (200) includes a number of connection ribs (211) inserted into and connected to a hub hole (120) of the hub mounting section (110), the connection ribs (211) receive a back cap (500), and the back cap (500) receives a vibration damping member (600) to be in contact together.

11. The vibration damping apparatus for an automobile wheel according to claim 10, wherein the back cap (500) includes a skirt portion (510) which is inclined inwardly at its one side, to support the vibration damping member (600) inserted into the back cap (500).
